(19) United States
(12) Patent Application Publication
(10) Pub. No.: US 2008/0102344 A1
(43) Pub. Date: May 1, 2008

(54) Single Cell And Method For Producing Single Cell, Fuel Cell And Method For Producing Fuel Cell

(75) Inventor: Akira Shimizu, Aichi (JP)

Correspondence Address: OLIFF & BERRIDGE, PLC, P.O. BOX 320850, ALEXANDRIA, VA, 22320-4850, US

(73) Assignee: Toyota Jidosha kabushiki Kaisha, Toyota-shi (JP)

(21) Appl. No.: 11/661,295

(22) PCT Filed: Sep. 15, 2005
(86) PCT No.: PCT/JP05/17439

§ 371 Date: Feb. 27, 2007

(30) Foreign Application Priority Data
Sep. 24, 2004 (JP) 2004-277349

(51) Int. Cl. H01M 8/02; B29C 39/00

(52) U.S. Cl. 429/35; 264/259; 429/34

(57) ABSTRACT

A single cell ensuring appropriate bonding of the components while suitably enhancing the productivity, a producing method of the single cell, a fuel cell, and a producing method of the fuel cell are provided. The single cell (2) is formed by stacking a plurality of components constituting the single cell (2) of a fuel cell (1), wherein peripheral portions of at least some components among the plurality of components are molded with a resin (94) along the circumferential direction to be molded integrally. The components to be molded are a MEA (11) and a pair of separators (12a, 12b) sandwiching the MEA (11).

### BACKGROUND

The present invention relates to a single cell constituting a minimum power-generating unit in a fuel cell, and particularly relates to a single cell formed by stacking components constituting a single cell, a producing method of the single cell, a fuel cell, and a producing method of the fuel cell.

In general, a single cell of a polymer electrolyte type is configured with a MEA (Membrane Electrode Assembly), which consists of an electrolyte membrane and a pair of electrodes arranged on opposing sides of the electrolyte membrane, and a pair of separators sandwiching the MEA therebetween, and has a stacked configuration as a whole (see Japanese Patent Laid-Open No. 2003-86229 (page 3 and FIG. 2), for example). The single cell generates power as oxidizing gas and fuel gas are supplied to the respective electrodes through gas flow paths formed in the corresponding separators. A fuel cell having a stack structure has a stacked plurality of single cells. When producing the single cell in Japanese Patent Laid-Open No. 2003-86229, an adhesive is applied to prescribed positions on the opposing surfaces of the separators, to fix the separators with the adhesive.

Another single cell having a configuration different from the above-described stacked configuration is also known (see Japanese Patent Laid-Open No. 2004-6419 (page 6 and FIG. 1), for example). This single cell has an electrolyte membrane member formed with a MEA and a pair of frames of frame shape that sandwich the rim portion of the electrolyte membrane of the MEA therebetween. A collector plate provided with gas flow paths is arranged on each side of the electrolyte membrane member, and a separator is arranged on the outside of each collector plate. In the case of forming a signal cell by integrating those components as well, an adhesive is used between the frame and the rim portion of the electrolyte membrane as well as between the frame and the separator.

When an adhesive is used for bonding the components as in the case of the conventional producing method of a single cell, the setting time therefor is required. It thus takes a long time until the components are bonded reliably, making it difficult to improve the productivity of the single cell. The similar problem would arise when stacking the single cells.

### SUMMARY

An object of the present invention is to provide a single cell ensuring appropriate bonding of the components while suitably enhancing the productivity, a producing method of the single cell, a fuel cell, and a producing method of the fuel cell.

To achieve the above object, according to the present invention, there is provided a single cell that has a stacked plurality of components constituting a single cell of a fuel cell. The plurality of components include a MEA and a pair of separators sandwiching the MEA, and peripheral portions of the MEA and each of the separators are molded with a resin along a circumferential direction to be bonded integrally.

With this configuration, it is possible to bond the three components of the MEA and the pair of separators simultaneously (for example in one molding step). Further, since the bonding is carried out by molding with a resin, it is possible to bond the components rapidly and appropriately. This can reduce the time required for producing the single cell by the setting time of an adhesive compared to the case of using the adhesive, and thus can enhance the productivity of the single cell. Furthermore, since the peripheral portions of the components are molded, the sealing efficiency between the components can be guaranteed by the resin.

Herein, the fuel cell is not restricted to a polymer electrolyte type fuel cell suitable for a fuel cell vehicle, but may be of other types such as a phosphoric acid type fuel cell. The plurality of components constituting the fuel cell generally include a MEA made, e.g., of an electrolyte membrane and electrodes as will be described later, and separators. In the case of the configuration as in Japanese Patent Laid-Open No. 2004-6419 described above, however, the frame-shaped member is also included in the components constituting the single cell.

According to an embodiment of the single cell of the present invention, preferably, a seal member is provided between the MEA and each of the separators to seal between the MEA and the corresponding separator, and the peripheral portions of the MEA and each of the separators are molded with the resin to be bonded integrally with an outer peripheral surface of the corresponding seal member.

With this configuration, the flow of the resin toward the inside of the single cell (inward between the separator and the MEA) can be prevented by the seal member at the time of molding. After the molding, the seal member cooperates with the molded resin to appropriately seal between the MEA and each of the separators. Preferably, each separator is provided with a restricting portion that restricts the movement of the seal member at the time of molding.

Further, preferably, the electrolyte membrane of the MEA has an area larger than that of a pair of electrodes provided on opposite sides of the electrolyte membrane, and each seal member directly seals between the peripheral portion of the electrolyte membrane on an outside of the electrode and the corresponding separator.

According to an embodiment of the single cell of the present invention, preferably, the seal member is apart from a flow path portion of the separator.

Further, preferably, the single cell has a power-generating region and a non-power-generating region in a plane, and the seal member is provided in the non-power-generating region. The peripheral portion of the non-power-generating region may be molded with a resin along the circumferential direction.

According to an embodiment of the single cell of the present invention, the seal member may include a main seal part that continuously surrounds all the flow paths related to a first fluid of the separator, and a plurality of sub seal parts that surround the flow paths related to a fluid different from the first fluid of the separator.

To achieve the above object, according to the present invention, there is provided another single cell has a stacked plurality of components constituting a single cell of a fuel cell. The single cell includes a seal member provided between at least some components among the plurality of components to seal between the components. Peripheral portions of the components sandwiching the seal member are molded with a resin along a circumferential direction to be integrally bonded with an outer peripheral surface of the seal member, and a fluid path located at least on an outside of the seal member is configured such that a masking member for preventing flow of the resin into the path at the time of molding can be arranged in the path.

From another point of view, according to the present invention, there is provided another single cell has a stacked plurality of components constituting the single cell of a fuel cell. The fuel cell includes a seal member provided between at least some components among the plurality of components to seal between the components. Peripheral portions of the components sandwiching the seal member are molded with a resin along a circumferential direction, in a state where a masking member is arranged in a fluid path located at least on an outside of the seal member, to be integrally bonded with an outer peripheral surface of the seal member.

With these configurations, bonding between the components are carried out by molding with a resin, so that it is possible to rapidly and appropriately bond the components, and thus to improve the productivity of the single cell. At the time of molding, the seal member can prevent the resin from flowing inward between the components. Further, although there is a possibility that the resin may flow into the fluid path located on the outside of the seal member at the time of molding, a masking member can be arranged upon molding as described above, making it possible to appropriately and easily secure the fluid path. Further, after the bonding, the seal member cooperates with the molded resin, to appropriately seal between the components.

According to an embodiment of the single cell of the present invention, preferably, the at least some components sandwiching the seal member are a separator and a MEA, and the flow path in which the masking member is arranged is a manifold portion for a fluid that is formed in the separator.

With this configuration, it is possible to appropriately and rapidly bond the MEA and the separator together with the seal member, and it is also possible to prevent the resin from flowing into the manifold portion at the time of molding. This ensures that the gases such as the fuel gas and the oxidizing gas can be supplied appropriately to the MEA via the manifold portions, and that the cooling medium such as the coolant can be supplied to the single cell via the manifold portions.

Similarly, according to an embodiment of the single cell of the present invention, preferably, the at least some components sandwiching the seal member include a separator and a MEA, and the separator is provided with: a gas flow path facing an electrode of the MEA; an inlet-side manifold portion for introducing a fluid to the gas flow path; an inlet-side communication path communicating the gas flow path with the inlet-side manifold portion; an outlet-side manifold portion for letting out the fluid from the gas flow path; and an outlet-side communication path communicating the gas flow path with the outlet-side manifold portion. Further, preferably, the fluid path in which the masking member is arranged corresponds to the inlet-side communication path and the outlet-side communication path.

With this configuration, it is possible to prevent the resin from flowing into the inlet-side communication path and the outlet-side communication path at the time of molding, and to appropriately supply the fuel gas and the oxidizing gas to the MEA in a similar manner as described above.

The gas flow path may be configured with a straight flow path, or may be configured with a serpentine flow path.

According to a preferred embodiment of the single cell of the present invention, the MEA may have an electrolyte membrane and a pair of electrodes arranged on opposite sides of the electrolyte membrane, and the seal member may seal between a rim portion of the electrolyte membrane and the separator.

According to a preferred embodiment of the single cell of the present invention, the separator may have a restricting portion that restricts inward movement of the seal member.

Further, in consideration of how the present invention has been reached, the single cell may be configured as follows.

According to the present invention, there is provided a single cell has a stacked plurality of components constituting a single cell of a fuel cell, wherein peripheral portions of at least some components among the plurality of components are molded with a resin along a circumferential direction to be bonded integrally.

With this configuration, the bonding between the components is carried out by molding with a resin, so that it is possible to rapidly and appropriately bond the components. This can reduce the time required for producing the single cell by the setting time of an adhesive compared to the case of using the adhesive, and thus can enhance the productivity of the single cell. Furthermore, since the peripheral portions of the components are molded, the sealing efficiency between the components can be guaranteed by the resin.

In the case of the configuration as in Japanese Patent Laid-Open No. 2004-6419 described above, the plurality of components constituting the single cell may also include a frame-shaped member.

To achieve the above-described object, according to the present invention, there is provided a producing method of a single cell wherein a plurality of components are stacked to form the single cell of a fuel cell. The method includes a molding step of molding peripheral portions of at least some components among the plurality of components with a resin along a circumferential direction to be bonded integrally. The molding step is implemented by integrally bonding a MEA and a pair of separators sandwiching the MEA, the separators each having a fluid path formed therein.

With this configuration, it is possible to bond the three components of the MEA and the pair of separators simultaneously. Further, since the bonding is carried out by molding with a resin, it is possible to bond the components rapidly and appropriately. This can suitably reduce the time required for producing the single cell compared to the case of using an adhesive for bonding, and thus can enhance the productivity.

According to an embodiment of the present invention, preferably, the molding step is carried out in a state preventing flow of the resin into the fluid path.

With this configuration, it is possible to secure the fluid path appropriately and easily after the molding, similarly as described above.

According to an embodiment of the present invention, preferably, the molding step is carried out in a state where a masking member preventing flow of the resin into the fluid path is arranged in the fluid path, and the method further includes a removing step of removing the masking member from the fluid path after the molding step. Particularly, it is preferable that the fluid path in which the masking member is arranged is a manifold portion, or a communication path communicating the manifold portion with a gas flow path facing an electrode of the MEA.

With this configuration, it is possible to appropriately prevent the resin from flowing into the path such as the manifold portion or the communication path, for example, at the time of molding, with such a simple configuration that a masking member is arranged in the path. Accordingly, by removing the masking member after the molding, it is possible to provide a single cell having the fluid path secured appropriately.

Similarly, according to an embodiment of the present invention, preferably, the molding step is carried out in a state where the fluid path is surrounded by a seal member provided between the MEA and the separator.

With this configuration, the fluid path is surrounded by the seal member, so that the flow of the resin into the fluid path can be avoided. Accordingly, it is possible to secure the fluid path appropriately.

To achieve the above object, according to the present invention, there is provided a fuel cell formed by stacking a plurality of the above-described single cells of the present invention, wherein peripheral portions of the plurality of single cells are molded with a resin along a circumferential direction to be bonded integrally.

According to the present invention, there is provided another fuel cell formed by stacking a plurality of single cells, wherein peripheral portions of the plurality of single cells are molded with a resin along a circumferential direction to be bonded integrally.

According to the present invention, there is provided a producing method of a fuel cell wherein a plurality of single cells are stacked to form the fuel cell, which method includes: a molding step of molding peripheral portions of the plurality of single cells with a resin along a circumferential direction to be bonded integrally.

With these configurations, the bonding between the single cells is implemented by molding with a resin, so that it is possible to bond the single cells rapidly and appropriately. This can reduce the time required for producing the fuel cell compared to the case of using an adhesive, and thus can enhance the productivity of the fuel cell.

According to an embodiment of the present invention, preferably, the molding step also includes the step of molding a plurality of components constituting the single cell with the resin to be bonded integrally.

With this configuration, a plurality of single cells are molded in the state where they are stacked in an unbonded state, rather than molding the single cell in the state where all the plurality of components constituting the single cell are bonded, and therefore, the bonding between the single cells and the bonding between the components constituting the single cell are carried out simultaneously. This can further reduce the time required for producing the fuel cell.

According to the single cell and the producing method of the single cell of the present invention as described above, it is possible to rapidly bond the components, and thus to enhance the productivity appropriately.

According to the fuel cell and the producing method of the fuel cell of the present invention as described above, it is possible to rapidly bond a plurality of single cells, and thus to similarly enhance the productivity appropriately.

### DESCRIPTION OF THE DRAWINGS

FIG. 1 is a perspective view showing a fuel cell according to a first embodiment.

FIG. 2 is an exploded perspective view showing a single cell of the fuel cell according to the first embodiment in a disassembled state.

FIG. 3 is a cross sectional view of the fuel cell according to the first embodiment, showing a configuration of two single cells adjacent to each other.

FIG. 4 is a diagram similar to FIG. 2, illustrating a producing method of the fuel cell according to the first embodiment.

FIG. 5 shows a configuration of a first masking member for a path according to the first embodiment, illustrating the state where the first masking member is applied to a communication path.

FIG. 6 shows a configuration of a second masking member for a manifold according to the first embodiment, illustrating the state where the second masking member is inserted through manifolds of a plurality of single cells.

FIG. 7 is a diagram illustrating a molding step of the producing method of the fuel cell according to the first embodiment, showing the state where single cells are placed in a mold.

FIG. 8 is an exploded perspective view showing a single cell of a fuel cell according to a second embodiment in a disassembled state.

### DETAILED DESCRIPTION

Hereinafter, a fuel cell according to a preferred embodiment of the present invention will be described with reference to the accompanying drawings. This fuel cell is formed by stacking a plurality of single cells as the minimum power-generating units, wherein components constituting the single cell as well as the single cells are integrally bonded by molding with a resin, thereby enhancing productivities of the single cell and the fuel cell. Hereinafter, a polymer electrolyte type fuel cell, which is suitable to be mounted on a vehicle, will be explained by way of example.

### First Embodiment

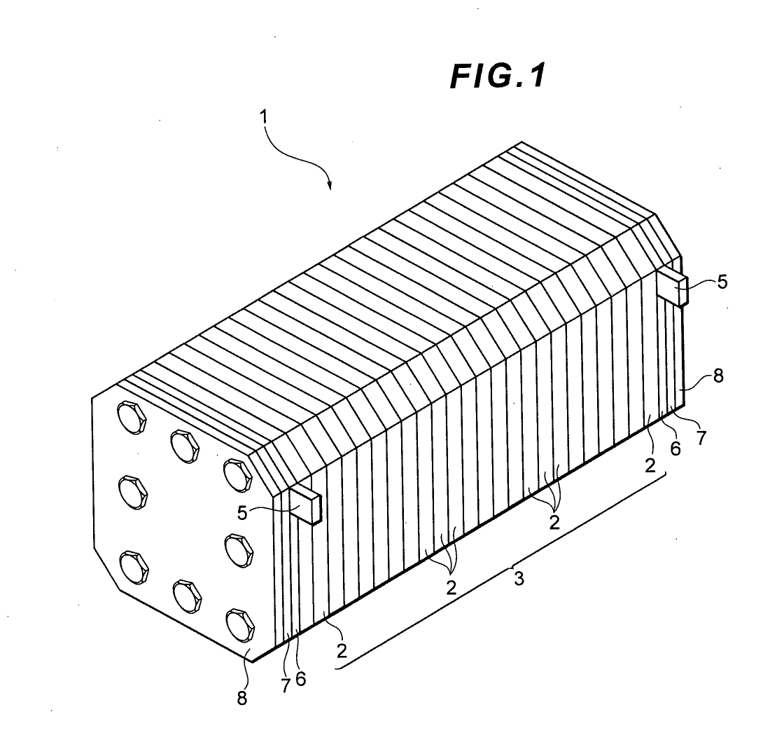

As shown in FIG. 1, a fuel cell 1 has a stack body 3 having a plurality of single cells 2 stacked one on another. The fuel cell 1 further includes a collector plate 6 provided with an output terminal 5, an insulating plate 7 and an end plate 8 arranged in this order on the outside of each of the single cells 2, 2 located at the respective ends of the stack body 3. The fuel cell 1 is applied with a predetermined compressive force in the stacking direction of the single cells 2, as an unillustrated tension plate provided over both end plates 8, 8 is bolted to each end plate 8, 8.

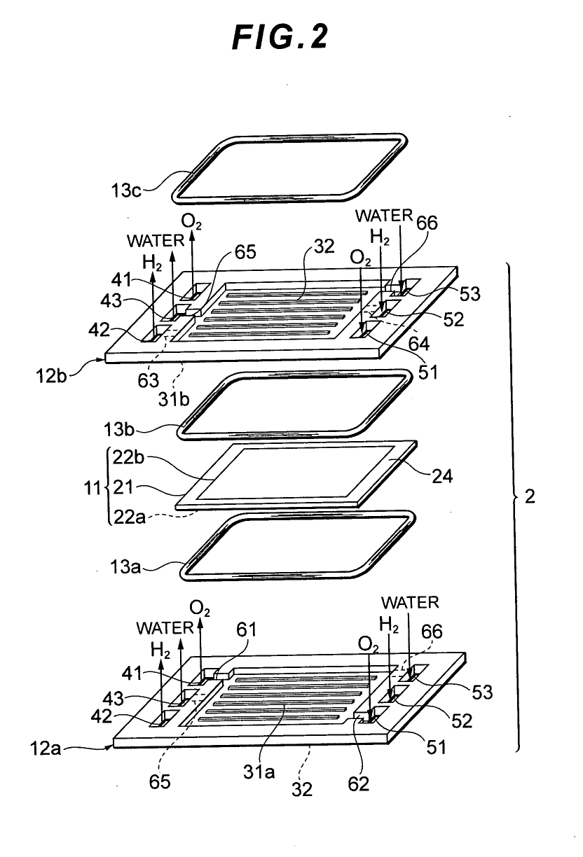

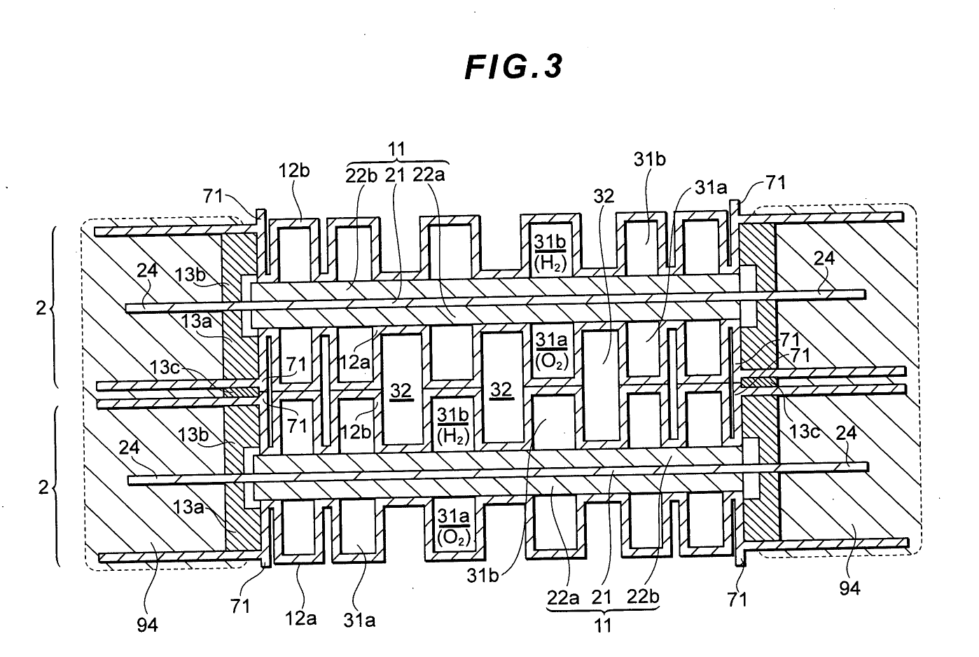

As shown in FIGS. 2 and 3, a single cell 2 is configured with a MEA 11 and a pair of separators 12a, 12b sandwiching the MEA 11 therebetween, and has a stacked configuration as a whole. The MEA 11 and the separators 12a, 12b are components of approximately planar shape, each having a rectangular outer shape as seen in two dimensions, with the outer shape of the MEA 11 being made slightly smaller than the outer shape of each of the separators 12a, 12b. As will be described later in detail, the MEA 11 and each of the separators 12a, 12b have their peripheral portions molded with a molding resin 94 together with first seal members 13a, 13b.

The MEA 11 is configured with an electrolyte membrane 21, which is an ion-exchange membrane made of a polymer material, and a pair of electrodes 22a, 22b (cathode and anode) sandwiching the electrolyte membrane 21 from its opposite sides, and has a stacked configuration as a whole. The electrolyte membrane 21 is sized slightly larger than each of the electrodes 22a, 22b. The electrodes 22a, 22b are bonded to the electrolyte membrane 21 by hot pressing, for example, leaving the rim portion 24 of the electrolyte membrane 21.

The electrodes 22a, 22b are each formed, e.g., with a porous carbon material (diffusion layer) to which a catalyst such as platinum is bound. One electrode 22a (cathode) is supplied with an oxidizing gas such as air, oxidant or the like, while the other electrode 22b (anode) is supplied with a hydrogen gas as a fuel gas. These two gases cause electrochemical reaction in the MEA 11, whereby the single cell 2 obtains electromotive force.

Each separator 12a, 12b is made of a gas-impermeable conductive material. The conductive material may be, for example, carbon, a hard resin having conductivity, or a metal such as aluminum, stainless steel and the like. The base of the separators 12a, 12b of the present embodiment is formed with a metal of a plate shape, with its surface on the electrode side being coated with a film that is highly resistant to corrosion.

The separators 12a, 12b each have a plurality of protrusions and depressions on both surfaces, which are formed by press forming the portions of the separators 12a, 12b facing the electrodes 22a, 22b. The protrusions and depressions extend in one direction, which constitute gas flow paths 31a for the oxidizing gas, gas flow paths 31b for the hydrogen gas, and coolant flow paths 32.

Specifically, on the inner surface of the separator 12a facing the electrode 22a, a plurality of straight gas flow paths 31a for the oxidizing gas are formed, and a plurality of straight coolant flow paths 32 are formed on the outer surface on the opposite side. Similarly, a plurality of straight gas flow paths 31b for the hydrogen gas are formed on the inner surface of the separator 12b facing the electrode 22b, and on the outer surface on the opposite side, a plurality of straight coolant flow paths 32 are formed.

The gas flow paths 31a and the gas flow paths 31b in the single cell 2 extend in parallel in the same direction, facing each other in alignment while sandwiching the MEA 11 therebetween. For the adjacent two single cells 2 and 2, the outer surface of the separator 12a of one single cell 2 and the outer surface of the separator 12b of the adjacent single cell 2 are butted against each other, so that their coolant flow paths 32 are connected together to form a rectangular flow path cross section. As will be described later, the separator 12a and the separator 12b of the adjacent single cells 2 and 2 have their peripheral portions molded with a molding resin 94.

A manifold 41 on the inlet side of the oxidizing gas, a manifold 42 on the inlet side of the hydrogen gas, and a manifold 43 on the inlet side of the coolant are formed in a rectangular shape to penetrate through one end portion of each of the separators 12a, 12b,. A manifold 51 on the outlet side of the oxidizing gas, a manifold 52 on the outlet side of the hydrogen gas, and a manifold 53 on the outlet side of the coolant are formed in a rectangular shape to penetrate through the other end portion of each of the separators 12a, 12b.

The manifolds 41 and 51 for the oxidizing gas in the separator 12a communicate with the gas flow paths 31a for the oxidizing gas via a communication path 61 on the inlet side and a communication path 62 on the outlet side that are formed in a groove shape at the separator 12a. Similarly, the manifolds 42 and 52 for the hydrogen gas in the separator 12b communicate with the gas flow paths 31b for the hydrogen gas via a communication path 63 on the inlet side and a communication path 64 on the outlet side that are formed in a groove shape at the separator 12b.

Further, the manifolds 43 and 53 for the coolant in each of the separators 12a, 12b communicate with the coolant flow paths 32 via a communication path 65 on the inlet side and a communication path 66 on the outlet side that are formed in a groove shape at each separator 12a, 12b. With such configurations of the separators 12a, 12b, the oxidizing gas, the hydrogen gas and the coolant are appropriately supplied to the single cell 2.

For example, the oxidizing gas is introduced from the manifold 41 of the separator 12a via the communication path 61 to the gas flow paths 31a, where it is used for power generation by the MEA 11, and then let out via the communication path 62 to the manifold 51. While the oxidizing gas flows through the manifolds 41 and 51 in the separator 12b, it is not let in toward the inside of the separator 12b. Although the gas flow paths 31a, 31b and the coolant flow paths 32 are explained as being straight flow paths by way of example in the present embodiment, it is of course possible to form these flow paths 31a, 31b, and 32 with serpentine flow paths.

The first seal members 13a, 13b are formed in the identical frame shape. First seal member 13a is provided between the MEA 11 and the separator 12a to seal between them. More specifically, the first seal member 13a is provided between the rim portion 24 of the electrolyte membrane 21 and a surface of the separator 12a apart from the gas flow paths 31a. Similarly, first seal member 13b is provided between the rim portion 24 of the electrolyte membrane 21 and a surface of the separator 12b apart from the gas flow paths 31b to seal between them.

Further, a second seal member 13c with a frame shape is provided between the separator 12a and the separator 12b of the adjacent single cells 2 and 2. The second seal member 13c is provided between a surface of the separator 12a apart from the coolant flow paths 32 and a surface of the separator 12b apart from the coolant flow paths 32 to seal between them. As such, of the various paths for the fluids (31a, 31b, 32, 41-43, 51-53, 61-66) of the separators 12a and 12b, the paths located outside of the first seal members 13a, 13b and the second seal member 13c are the manifolds 41-43 on the inlet side and the manifolds 51-53 on the outlet side of the fluids.

Although not shown in FIG. 2, the first seal members 13a, 13b have stepped portions in the inner peripheries on the electrolyte membrane 21 side, in consideration of the electrodes 22a, 22b. Further, the separators 12a, 12b are formed to correspond to the first seal members 13a, 13b and the second seal member 13c, thus having depressions to accommodate the first seal members 13a, 13b and the second seal member 13c, and restricting portions 71 to restrict the inward movement of the first seal members 13a, 13b and the second seal member 13c. Although the first seal members 13a, 13b and the second seal member 13c are different in shape in FIG. 3, it is of course possible to form them in the same shape.

The first seal members 13a, 13b and the second seal member 13c are not necessarily indispensable components, from the standpoint of securing the function as the fuel cell 1 (single cell 2). However, at the time of molding the peripheral portions of the MEA 11 and the separators 12a, 12b in the single cell 2 with the molding resin 94, the first seal members 13a, 13b function to prevent the molding resin 94 from flowing inward of the single cell 2. Further, the second seal member 13c similarly functions to prevent the flow of the molding resin 94 toward the inside of the single cells 2 at the time of molding between the single cells 2. Furthermore, after the molding, the first seal members 13a, 13b and the second seal member 13c cooperate with the molding resin 94 thus molded, to appropriately seal between the MEA 11 and each of the separators 12a, 12b, and between the separator 12a and the separator 12b of the adjacent single cells 2.

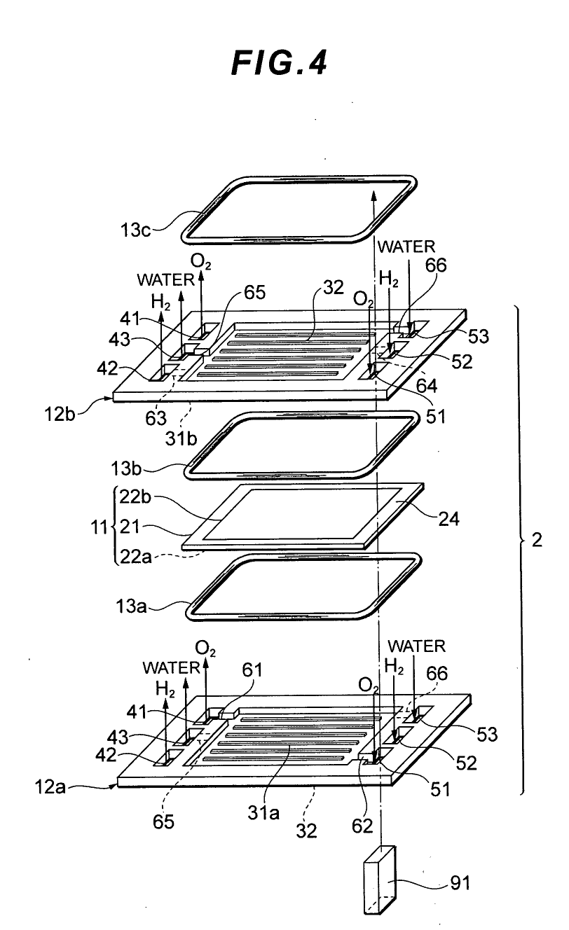

Referring to FIGS. 4 to 7, a producing method of the fuel cell 1 will now be described together with an assembling process of the components of the single cell 2. In the assembling process of the single cell 2, the components are molded together, which molding is carried out during the process of molding for example 10 to 20 single cells 2 at the same time.

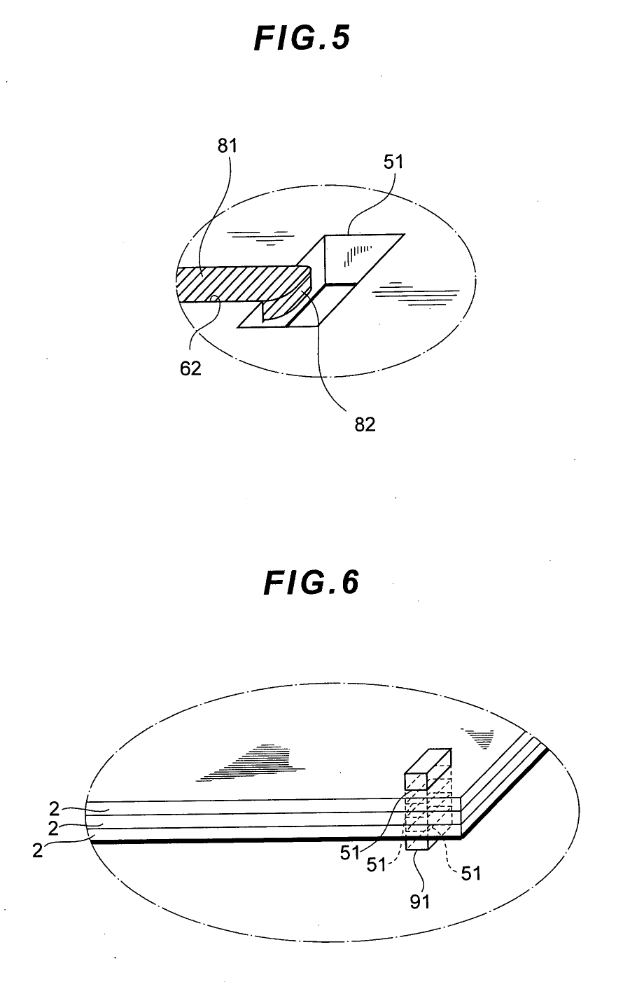

Firstly, in a preparatory step, the separator 12a is set, and the first seal member 13a is provided at a predetermined position on the separator 12a. At this time, in order to secure the flow path of the oxidizing gas, a first masking member 81 for a path as shown in FIG. 5 is fitted and applied to each of the communication paths 61, 62 of the separator 12a. As will be described later, the first masking member 81 is provided for each of the communication paths (61-66) of the separators 12a, 12b, each masking member having the similar configuration. Here, the first masking member 81 will be described in conjunction with the communication path 62 as a representative of the communication paths.

The first masking member 81 has a shape corresponding to the width and depth of the groove of the communication path 62, and is formed of a material having flexibility. By applying the first masking member 81 to the communication path 62, the molding resin 94 is prevented from flowing into the communication path 62 at the time of molding. In this case, the first masking member 81 is applied to the communication path 62 in such a manner that a portion 82 in the longitudinal direction of the first masking member 81 protrudes into the manifold 51. This makes it possible to access the protruding portion 82 of the first masking member 81 from the manifold 51 after the molding to extract the first masking member 81 from the communication path 62 via the protruding portion 82, and thus ensures that the first masking member 81 can be extracted easily from the communication path 62.

In the next step, the MEA 11 and the first seal member 13b are provided at predetermined positions such that they are stacked in this order on the separator 12a and the first seal member 13a. The separator 12b is then stacked on them at a predetermined position. At this time, in order to secure the flow path of the hydrogen gas, the first masking member 81 is fitted and applied to each of the communication paths 63, 64 of the separator 12b in a similar manner as described above. Thereafter, the second seal member 13c is provided on the separator 12b, in which time again, the first masking member 81 is fitted and applied to each of the communication paths 65, 66 of the separator 12b in a similar manner as described above so as to secure the flow path of the coolant.

The above-described steps are repeated for a predetermined number of (for example 10 to 20) single cells 2, to stack the predetermined number of single cells 2 in an unbonded state. In this state, the totally six manifolds (41-43, 51-53) of the respective single cells 2 are each aligned in the cell stacking direction. Here, the second masking member 91 for a manifold, as shown in FIGS. 4 and 6, is inserted into each of the manifolds (41-43, 51-53). Each second masking member 91 has the similar configuration, and hereinafter, the second masking member 91 will be described in conjunction with the manifold 51 as a representative of the manifolds.

The second masking member 91 is formed with a hard quadrangular prism, corresponding to the size and the rectangular shape of the manifold 51. The second masking member 91 has a height set greater than the heights (thicknesses) of the plurality of single cells 2 stacked in the unbonded state. The second masking member 91 inserted into the manifold 51 extends through the plurality of single cells 2, while bowing the protruding portions 82 of the first masking members 81 in the manifolds 51 of the single cells 2. Inserting the second masking member 91 into the manifolds 51 can prevent the molding resin 94 from flowing into the manifolds 51 at the time of molding.

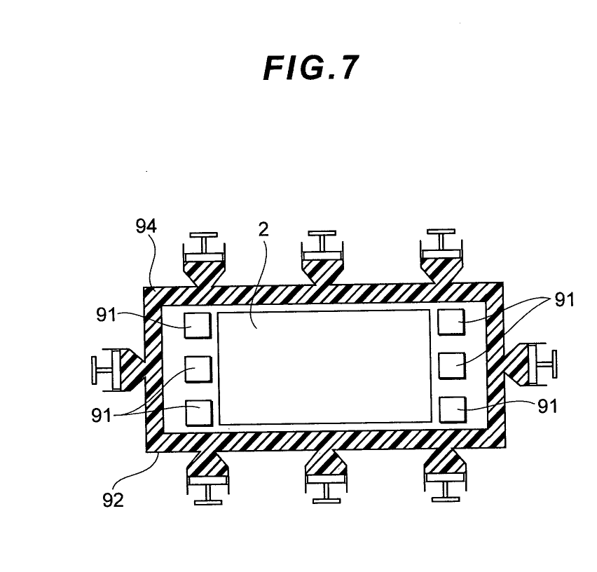

The following step is the molding step, in which the plurality of single cells 2 having the second masking members 91 inserted therethrough are placed in a mold 92, as shown in FIG. 7, and a liquid molding resin 94 (molding material) is introduced into the mold 92 at a prescribed pressure. The molding resin 94 flows around the peripheral portions of the single cells 2 in the circumferential direction. At this time, the first seal members 13a, 13b prevent the molding resin 94 from flowing in the inward direction of the single cell 2 (gas flow paths 31a, 31b) between the MEA 11 and the respective separators 12a, 12b.

Further, at the time of introducing the molding resin 94, the second seal member 13c prevents the molding resin 94 from flowing in the inward direction of the single cells 2 (coolant flow paths 32) between the separator 12a and the separator 12b of the adjacent single cells 2. Meanwhile, the restricting portions 71 formed at the separators 12a, 12b restrict the movement of the first seal members 13a, 13b and the second seal member 13c in the inward direction of the single cell 2 at the time of introducing the molding resin 94.

Furthermore, upon introduction of the molding resin 94, the first masking members 81 and the second masking members 91 prevent the flow of the molding resin 94 into the corresponding communication paths (61-66) and the corresponding manifolds (41-43, 51-53). In this manner, the above-described configuration can appropriately prevent the flow of the molding resin 94 into the flow paths (31a, 31b, 32, 41-43, 51-53, 61-66) formed at the separators 12a, 12b.

When the molding resin 94 is cooled and hardened, the mold 92 is removed, whereby the molding step is completed. As a result of this molding step, each single cell 2 attains the state as shown in FIG. 3. Specifically, the peripheral portions of the MEA 11 and the separator 12a of the single cell 2 are bonded by the molded molding resin 94 along the circumferential direction integrally with the outer peripheral surface of the first seal member 13a. Similarly, the peripheral portions of the MEA 11 and the separator 12b of the single cell 2 are bonded by the molded molding resin 94 along the circumferential direction integrally with the outer peripheral surface of the first seal member 13b. Furthermore, the peripheral portions of the separator 12a and the separator 12b of the adjacent single cells 2 are bonded by the molded molding resin 94 along the circumferential direction integrally with the outer peripheral surface of the second seal member 13c.

In this manner, by the end of the molding step, the three components constituting the single cell 2, i.e., the MEA 11 and the separators 12a and 12b, are bonded simultaneously by the molding resin 94, and the single cells 2 and 2 are also bonded by the molding resin 94. As the molding resin 94, for example silicone rubber having good heat resistance and electrical insulation properties may be used, in which case the setting time (bonding time) of the molding resin 94 is about one minute. Various resins such as fluorine rubber and the like may also be used as the molding resin 94.

Hereinafter, the peripheral portions and the circumferential direction of the components molded with the molding resin 94 to be integrally bonded will be described in detail. When focusing on a single cell 2, the single cell 2 has a plurality of approximately planar components (MEA 11, separator 12a and separator 12b) stacked and bonded together as described above, and has a structure having a power-generating region and a non-power-generating region in its plane. The “peripheral portion” of the component constituting the single cell 2 refers to a region including at least a part of the non-power-generating region. In other words, in the approximately planar single cell 2 having a prescribed thickness, the “peripheral portion” corresponds to the rim portion of the approximately planar single cell 2. Further, the circumferential direction refers to the direction along the circumference of this rim portion.

To describe the power-generating region and the non-power-generating region in detail, the power-generating region is the region including the electrodes 22a, 22b of the MEA 11, and the non-power-generating region is the region on the outside of the power-generating region, which is the region off the gas flow paths 31a, 31b of the separators 12a, 12b.

After the molding step, the second masking member 91 is removed from every one of the manifolds (41-43, 51-53). When the second masking member 91 is removed, the portion 82 of the first masking member 81 may be exposed in the manifold (41-43, 51-53), and thus, each of the first masking members 81 is removed from the communication path (61-66) by accessing it from the corresponding manifold (41-43, 51-53). After a series of such removing steps, a stack having a predetermined number of stacked single cells 2 is obtained.

At the final stage of the producing process of the fuel cell 1, a predetermined number of such stacks, each made of a plurality of single cells 2, are produced and stacked to assemble a stack body 3. The stack body 3, the collector plates 6, the insulating plates 7 and the end plates 8 are then stacked and predetermined compressive force is applied in the stacking direction of the single cells 2, whereby the fuel cell 1 is completed.

As described above, at the time of producing the fuel cell 1, the components (MEA 11, separators 12a, 12b) of the single cell 2 are bonded integrally by molding with the molding resin 94. In the case of using an adhesive for bonding the components, about ten minutes, for example, may be required for the setting time (bonding time) per single cell 2. In contrast, by integrally molding with the molding resin 94 as in the present embodiment, the bonding time per single cell 2 can be reduced considerably. Furthermore, a predetermined number of single cells 2 are integrally molded, which can further reduce the bonding time. Accordingly, it is possible to appropriately enhance the productivities (throughputs) of the single cell 2 and the fuel cell 1.

Although it has been configured such that a plurality of single cells 2 are stacked and the peripheral portions of the single cells 2 are also molded with the molding resin 94, it is of course possible to mold the peripheral portions of the MEA 11 and each of the separators 12a, 12b constituting the single cell 2 separately, for each single cell 2. Nevertheless, integral molding of a plurality of single cell 2 can appropriately enhance the throughput of the fuel cell 1, as described above.

### Second Embodiment

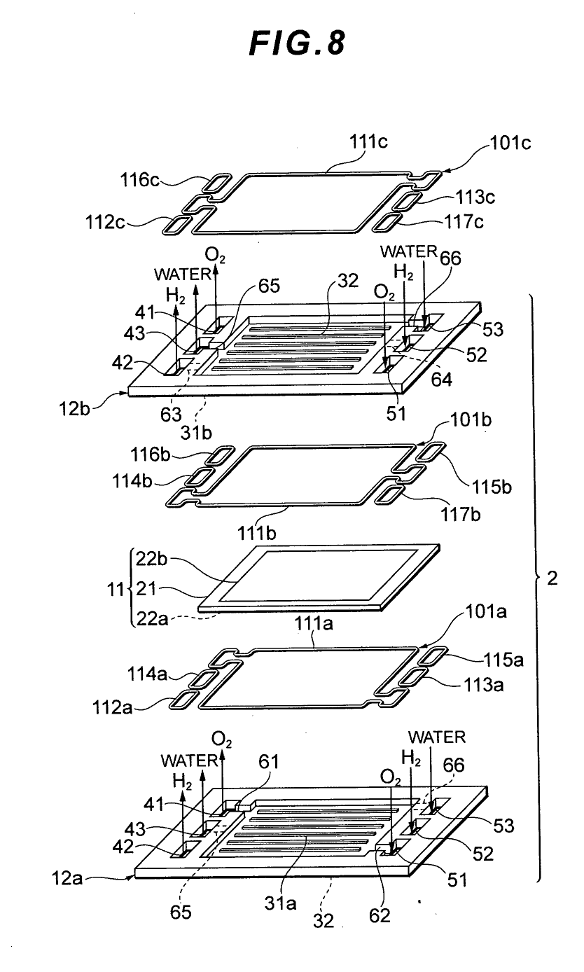

A fuel cell 1 and a single cell 2 according to the second embodiment will now be described with reference to FIG. 8. The second embodiment differs from the first embodiment primarily in the following two points: it differs in the configurations of the first seal members 101a, 101b and the second seal member 101c, and consequently it differs in that the second masking member 91 is not used in the molding step. In the following explanation, the portions common to those of the first embodiment are denoted by the same reference characters, and description thereof will not be repeated.

The first seal member 101a is formed with a first main seal part 111a continuously surrounding all the paths related to the oxidizing gas (gas flow paths 31a, manifolds 41, 51, and communication paths 61, 62) of the separator 12a on the MEA 11 side, frame-shaped first sub seal parts 112a and 113a respectively surrounding the inlet-side and outlet-side manifolds 42 and 52 for the hydrogen gas of the separator 12a on the MEA 11 side, and frame-shaped first sub seal parts 114a and 115a respectively surrounding the inlet-side and outlet-side manifolds 43 and 53 for the coolant of the separator 12a on the MEA 11 side. The first sub seal parts 112a-115a are each separate from the first main seal part 111a.

Similarly, the first seal member 101b is formed with a first main seal part 111b continuously surrounding all the paths related to the hydrogen gas (gas flow paths 31b, manifolds 42, 52, and communication paths 63,64) of the separator 12b on the MEA 11 side, frame-shaped first sub seal parts 116b and 117b respectively surrounding the inlet-side and outlet-side manifolds 41 and 51 for the oxygen gas of the separator 12b on the MEA 11 side, and frame-shaped first sub seal parts 114b and 115b respectively surrounding the inlet-side and outlet-side manifolds 43 and 53 for the coolant of the separator 12b on the MEA 11 side. The first sub seal parts 114b-117b are each separate from the first main seal part 111b.

Similarly, the second seal member 101c has a first main seal part 111c continuously surrounding all the paths related to the coolant (coolant flow paths 32, manifolds 43, 53, and communication paths 65, 66) of the separator 12b (12a) on the side facing the adjacent single cell 2. Further, the second seal member 101c has first sub seal parts 112c and 113c for the hydrogen gas and first sub seal parts 116c and 117c for the oxygen gas, which are each separate from the first main seal part 111c, similarly as in the cases of the first seal members 101a and 101b.

The producing process of the fuel cell 1 is substantially common with that of the first embodiment. Specifically, firstly in the preparatory step, the first masking member 81 is applied to each of the communication paths 61, 62 when providing the first seal member 101a at a predetermined position on the set separator 12a. Thereafter, the MEA 11 and the first seal member 101b are provided at predetermined positions so as to be stacked in this order, and then the separator 12b is stacked at a predetermined position. At this time as well, the first masking member 81 is applied to each of the communication paths 63, 64. Subsequently, when providing the second seal member 101c on the separator 12b, the first masking member 81 is similarly applied to each of the communication paths 65, 66.

The above-described steps are repeated to stack a predetermined number of single cells 2 in an unbonded state. At this time, the first main seal part 111a on the separator 12a is configured such that its sealing portion in the vicinity of the gas flow paths 31a and the communication paths 61, 62 closely contacts the rim portion 24 of the electrolyte membrane 21, and such that the remaining sealing portions in the vicinity of the manifolds 41, 51 closely contact the first sub seal parts 116b, 117b on the separator 12b side. The first main seal part 111b on the separator 12b is similarly configured to achieve close contact (description will not be repeated).

The molding step similar to that described above is carried out in this state, to implement integral bonding between the components (between the MEA 11 and each of the separators 12a, 12b) constituting the single cell 2, and also between the single cells 2. In the present embodiment, the first seal members 101a, 101b and the second seal member 101c prevent the molding resin 94 from flowing into the various paths (31a, 31b, 32, 41-43, 51-53, 61-66) of the separators 12a, 12b. After completion of the molding step, the first masking members 81 are removed, whereby a stack having a predetermined number of stacked single cells 2 is obtained.

As described above, according to the present embodiment as well, molding is used for bonding when producing the fuel cell 1, which can appropriately improve the throughputs of the signal cell 2 and the fuel cell 1. The separators 12a, 12b are formed to correspond to the first seal members 101a, 101b and the second seal member 101c, and are provided with prescribed depressions for accommodating them, restricting portions 71 for restricting the movement at the time of molding and others, similarly as in the first embodiment.

1. A single cell comprising:
a stacked plurality of components constituting a single cell of a fuel cell, wherein the plurality of components include a MEA, and a separator stacked on the MEA and having a fluid path formed therein,
the MEA and the separator being bonded integrally with a molded resin, and the path is configured such that a masking member for preventing flow of the resin into the path at the time of molding can be arranged in the path.

2. The single cell according to claim 1, further comprising a seal member arranged between the MEA and the separator to seal between the MEA and the separator, wherein
the MEA and the separator are bonded integrally with an outer peripheral surface of the seal member with the molded resin.

3. The single cell according to claim 2, wherein
the MEA has an electrolyte membrane and a pair of electrodes arranged on opposite sides of the electrolyte membrane, and
the seal member seals between a rim portion of the electrolyte membrane and the separator.

4. The single cell according to claim 2, wherein the seal member is apart from the path of the separator.

5. The single cell according to claim 2, wherein the separator has a restricting portion that restricts inward movement of the seal member.

6. The single cell according to claim 2, wherein
the single cell has a power-generating region and a non-power-generating region in a plane, and
the seal member is provided in the non-power-generating region.

7. The single cell according to claim 2, wherein the seal member includes a main seal part that continuously surrounds all the flow paths of the separator related to first fluid, and a plurality of sub seal parts that surround the flow paths of the separator related to fluid different from the first fluid.

8. The single cell according to claim 1, wherein
the single cell has a power-generating region and a non-power-generating region in a plane, and
a peripheral portion of the non-power-generating region is molded with the resin along a circumferential direction.

9. A single cell comprising:
a stacked plurality of components constituting a single cell of a fuel cell, and
a seal member provided between at least some components among the plurality of components to seal between the components; wherein
peripheral portions of the components sandwiching the seal member are molded with a resin along a circumferential direction to be integrally bonded with an outer peripheral surface of the seal member, and
a fluid path located at least on an outside of the seal member is configured such that a masking member for preventing flow of the resin into the path at the time of molding can be arranged in the path.

10. The single cell according to claim 9, wherein
the at least some components sandwiching the seal member are a separator and a MEA, and
the flow path in which the masking member is arranged is a manifold portion for fluid that is formed in the separator.

11. The single cell according to claim 9, wherein
the at least some components sandwiching the seal member are a separator and a MEA,
the separator having:
a gas flow path facing an electrode of the MEA;
an inlet-side manifold portion for introducing fluid to the gas flow path;
an inlet-side communication path communicating the gas flow path with the inlet-side manifold portion;
an outlet-side manifold portion for letting out fluid from the gas flow path; and
an outlet-side communication path communicating the gas flow path with the outlet-side manifold portion; and
the fluid path in which the masking member is arranged corresponds to the inlet-side communication path and the outlet-side communication path.

12. The single cell according to claim 1, wherein
the MEA has an electrolyte membrane and a pair of electrodes arranged on opposite sides of the electrolyte membrane, and
the seal member seals between a rim portion of the electrolyte membrane and the separator.

13. The single cell according to claim 10, wherein the separator has a restricting portion that restricts inward movement of the seal member.

14. A fuel cell comprising:
a stacked plurality of the single cells as recited in claim 1, wherein the plurality of single cells are bonded integrally with a molded resin.

15. A fuel cell comprising:
a stacked plurality of single cells having fluid paths, wherein
the plurality of single cells are bonded integrally with a molded resin, and
the path is configured such that a masking member for preventing flow of the resin into the path at the time of molding can be arranged in the path.

16. A producing method of a single cell of a fuel cell, comprising:
a molding step of molding a separator having a fluid path formed therein and a MEA with a resin to be bonded integrally, the molding step being carried out in a state preventing flow of the resin into the fluid path.

17. (canceled)

18. The producing method of a single cell according to claim 16, wherein the molding step is carried out in a state where a masking member for preventing flow of the resin into the fluid path is arranged in the fluid path, the method further comprising:
a removing step of removing the masking member from the fluid path after the molding step.

19. The producing method of a single cell according to claim 18, wherein the fluid path in which the masking member is arranged is a manifold portion, or a communication path communicating the manifold portion with a gas flow path facing an electrode of the MEA.

20. The producing method of a single cell according to claim 16, wherein the molding step is carried out in a state where the fluid path is surrounded by a seal member provided between the MEA and the separator.

21. A producing method of a fuel cell wherein a plurality of single cells having fluid paths are stacked to form the fuel cell, the method comprising:
a molding step of molding the plurality of single cells with a resin to be bonded integrally, the molding step being carried out in a state preventing flow of the resin into the path.

22. The producing method of a fuel cell according to claim 21, wherein the molding step also includes a molding a plurality of components constituting a single cell with the resin to be bonded integrally.

23. The single cell according to claim 1, wherein the separator is molded such that an outer peripheral surface of the separator is covered with the resin.
